(19) United States
(12) Patent Application Publication
(10) Pub. No.: US 2025/0256531 A1
(43) Pub. Date: Aug. 14, 2025

(54) TRAILER WHEEL WITH BUILT-IN CENTER CAP

(71) Applicant: Tredit Tire & Wheel Company, Inc., Elkhart, IN (US)

(72) Inventor: Jeffrey L. Stevens, Elkhart, IN (US)

(21) Appl. No.: 19/050,413

(22) Filed: Feb. 11, 2025

Related U.S. Application Data
(60) Provisional application No. 63/552,336, filed on Feb. 12, 2024.

(51) Int. Cl. B60B 7/00

(52) U.S. Cl. CPC B60B 7/0013

(57) ABSTRACT

A trailer wheel includes a built-in center cap integral with the trailer wheel. The trailer wheel further includes an opposing pair of circular outer edges with a tire-receiving body therebetween, and a plurality of spokes having first ends generally extending from one of the circular outer edges toward the built-in center cap and second ends extending to respective bottom portions of the built-in center cap. The respective bottom portions of the built-in center cap can extend in a curved manner to a body portion of the built-in center cap.

### CROSS REFERENCE TO RELATED APPLICATIONS

This application claims the benefit of U.S. provisional patent application Ser. No. 63/552,336, filed Feb. 12, 2024, which is incorporated by reference herein.

### FIELD OF THE INVENTION

One or more embodiments of the present invention relate to a trailer wheel with a built-in center cap.

### BACKGROUND OF THE INVENTION

Trailer wheels can include center caps which cover a central portion of the wheel. These center caps are conventionally separate components from the trailer wheel and are typically either inserted through a back central opening of the trailer wheel or snapped onto the face of the trailer wheel by some means. The center caps are generally made of a material (e.g., steel) different from the material of the wheel (e.g., aluminum). This material difference can cause galvanic corrosion, especially where the trailer wheels are used in marine applications.

There remains a need in the art for an improved trailer wheel.

### SUMMARY OF THE INVENTION

In one or more embodiments, the present invention provides a trailer wheel with a built-in center cap. The built-in center cap is integral with the trailer wheel. The trailer wheel further includes an opposing pair of circular outer edges with a tire-receiving body therebetween, the opposing pair of circular outer edges including an external circular outer edge and an internal circular outer edge; and a plurality of spokes having first ends generally extending from the external circular outer edge and a portion of the tire-receiving body toward the built-in center cap, and having second ends extending to respective bottom portions of the built-in center cap. The respective bottom portions of the built-in center cap can extend in a curved manner to a body portion of the built-in center cap. The body portion can be shaped as a generally frustoconical hollow body. The trailer wheel can have an outer diameter of from about 13 inches to about 18.5 inches. The trailer wheel is suitable for use with a tire with a tire pressure rating of from 50 psi to 125 psi.

### BRIEF DESCRIPTION OF THE DRAWINGS

FIG. 1 is a perspective view of a wheel with a built-in center cap, shown without a plug;

FIG. 2 is a side view of the wheel of FIG. 1;

FIG. 3 is a front view of an alternate wheel with a built-in center cap, with an alternate amount of lug holes, and shown without a plug;

FIG. 4 is a perspective view of the wheel of FIG. 1, shown with a plug shown in the form of a snap-in cap;

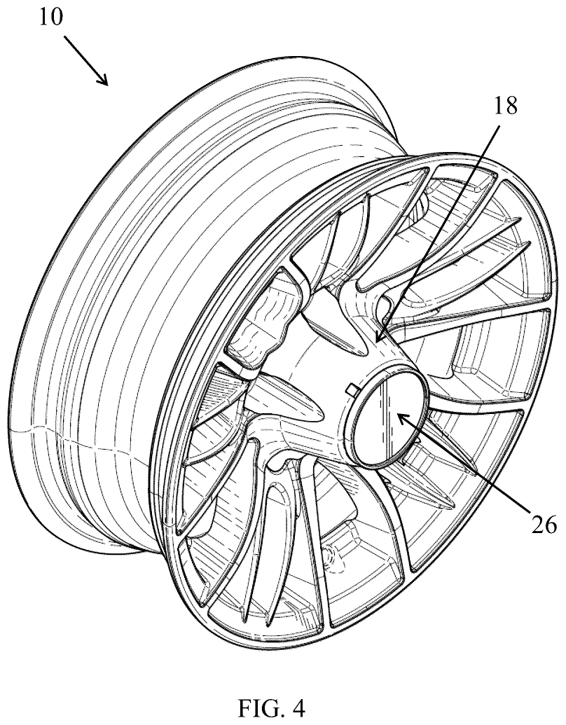

FIG. 5 is a side view of the wheel of FIG. 4; and

FIG. 6 is a side view of the snap-in cap of FIG. 4.

### DETAILED DESCRIPTION OF ILLUSTRATIVE EMBODIMENTS

One or more embodiments of the present invention relate to a wheel, such as for a trailer, with a built-in center cap. Advantageously, embodiments of the present invention avoid the need for a center cap which is a separate component than the wheel. Since the built-in center cap will be made from the same material as the rest of the trailer wheel, the built-in center cap will advantageously lead to reduced corrosion and ease of installation of the trailer wheel onto a trailer or other vehicular assembly designed to be hauled.

With reference to the Figures, a trailer wheel according to one or more embodiments is shown with the numeral 10. Trailer wheel 10, which may be referred to as wheel 10, includes an opposing pair of circular outer edges 12A, 12B, which may also be referred to as rims 12A, 12B or outer lips 12A, 12B, where the term outer is used here as being relative to the wheel 10 itself. The pair of rims 12A, 12B includes an external rim 12A, which may be referred to as an outer rim 12A, and an internal rim 12B, which may be referred to as an inner rim 12B, where the terms external/outer and internal/inner are used here relative to the configuration of the wheel when positioned on a trailer or other vehicular assembly.

Rims 12A, 12B have a tire-receiving body 14 in between, which may be referred to as barrel 14. A plurality of spokes 16 are positioned in a face of the trailer wheel 10 and generally extend from outer rim 12A and/or from at least a portion of barrel 14 and toward a built-in center cap 18, which may also be referred to as an integral center cap 18. More specifically, first ends of the spokes 16 generally extend from outer rim 12A and/or from at least a portion of barrel 14 toward second ends of the spokes 16 that are proximate to the center cap 18.

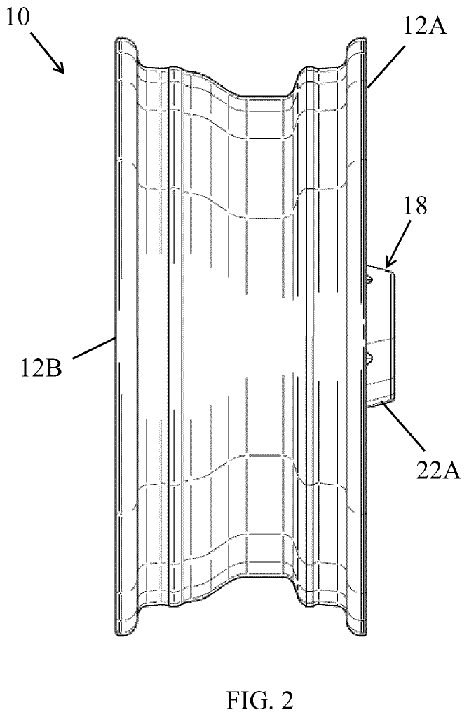

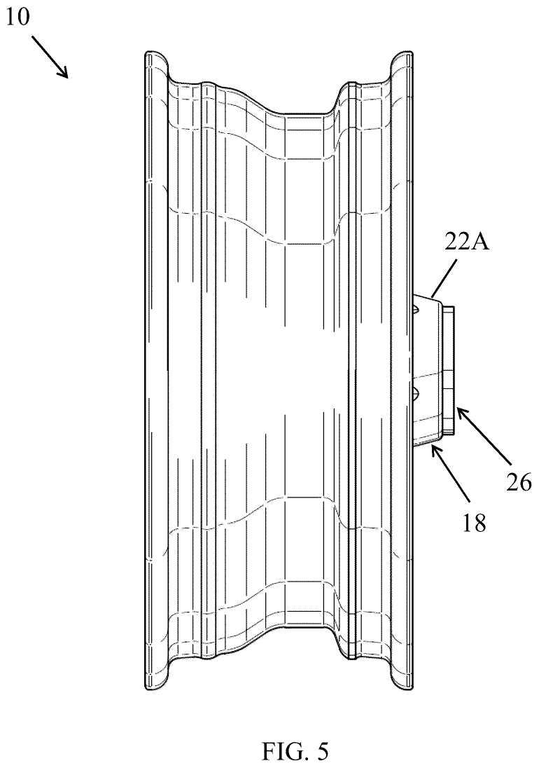

Top portions of the second ends of the spokes 16 extend to a bottom portion 20 of the built-in center cap 18. The bottom portion 20 of the built-in center cap 18 extends in a curved manner to a body portion 22 of the built-in center cap 18. The body portion 22 is hollow as to receive and fit an axle hub nose (not shown) therewithin. The body portion 22 can be coaxial with external rim 12A. As best seen in FIG. 2 and FIG. 5, the body portion 22 of the built-in center cap 18 can partially extend beyond external rim 12A as an extension portion 22A. The amount of extension of extension portion 22A can be characterized relative to the distance between rims 12A, 12B, which may be referred to as thickness of the tire-receiving body 14. The extension of extension portion 22A beyond external rim 12A may be from about 5% to about 20%, or from about 5% to about 15%, or from about 8% to about 12%, or from about 5% to about 10%, or from about 10% to about 15%, or about 5%, or about 10%, of the distance between rims 12A, 12B.

As shown in the Figures, the body portion 22 can be a generally frustoconical hollow body. In other embodiments, the body portion 22 might be a cylindrical hollow body or other suitable shape. The angle from the bottom portion 20 to an outermost portion 24 and the inner diameter of body portion 22 (i.e., the generally frustoconical hollow shape) can be sized as to receive and fit the axle hub nose within the body portion 22.

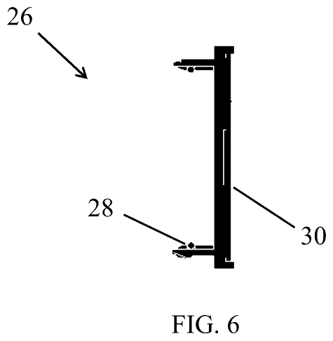

Outermost portion 24, which can be generally circular, is adapted to receive a plug 26, which may also be referred to as a snap-in cap 26. Plug 26 includes one or more legs 28 extending from a base 30 (FIG. 6). The one or more legs 28 will be positioned within body portion 22 in the installed position such that base 30 provides a protective covering. Plug 26 can be snapped-in or utilize a spring/tension securement. Plug 26 is removable in order to allow access to internal components, such as to grease bearings in an axle. Suitable materials for plug 26 include rubber, plastic, and metal, where suitable metals include metals matching the same material as the rest of the wheel 10. Outermost portion 24 can include a notch 32 for assistance with receiving plug 26 therein and/or with installation and removal of plug 26.

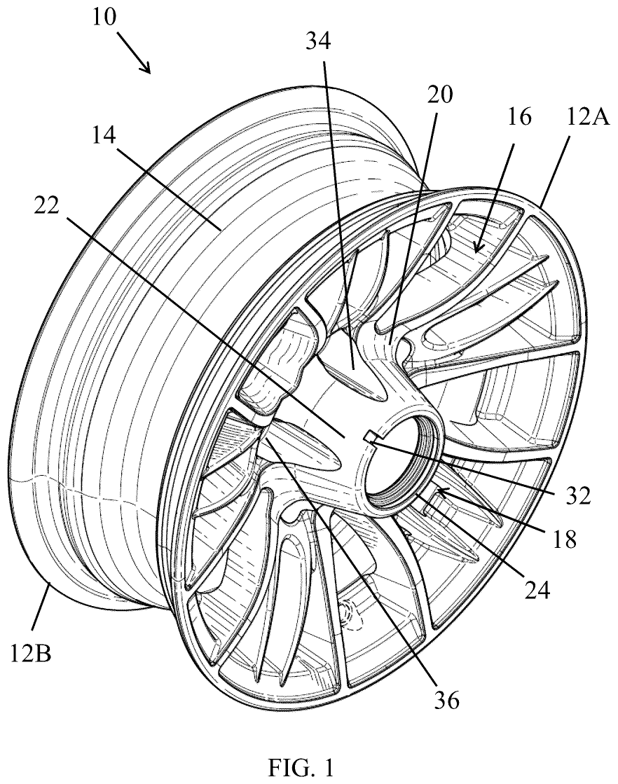

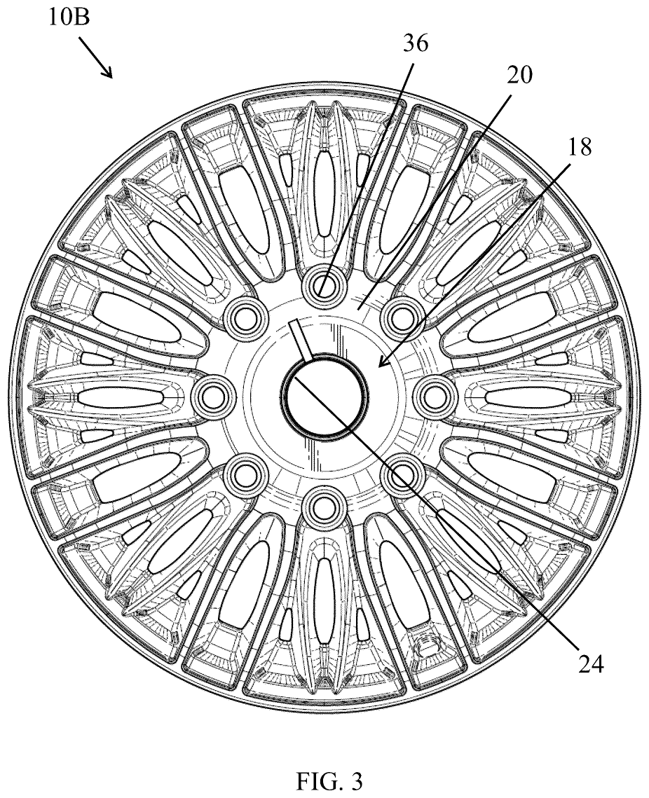

Body portion 22 includes external shaped hole portions 34 (FIG. 1) which extend into lug holes 36 (FIG. 3). In this way, a corresponding tool can be inserted into the external shaped hole portions 34 for securing lug nuts to the axle bolts/studs. Wheel 10 includes five lug holes 36, and wheel 10B includes eight lug holes 36, and other amounts of lug holes 36 will be suitable, such as six lug holes 36.

As mentioned above, built-in center cap 18 is advantageously integrally formed with the rest of the wheel 10, which should include built-in center cap 18 being made of the same material as the rest of the wheel 10. An exemplary material for wheel 10 is an aluminum alloy, which can be A356 aluminum alloy. Aluminum alloys, such as A356, can provide superior strength and eliminate the need for steel inserts at lug holes 36, which can also be referred to as stud holes 36, for installation of wheel 10. This similarity of materials of the built-in center cap 18 and the rest of the wheel 10 can result in reduced corrosion, especially where the wheels 10 are used in marine applications.

Installation of wheel 10 on a vehicle, such as a trailer, can also avoid the need to insert a separate center cap through the back of a wheel, and can avoid the need to attach a separate center cap to a face of a wheel, such as by spring clips or another fastener. Manufacturing of wheel 10 can also be done in a single mold, rather than needing to manufacture a center cap separately from a wheel.

As mentioned above, wheel 10 can be particularly suitable for use with a trailer. Tires for trailers generally require a higher pressure load (e.g., 50 psi to 125 psi) than passenger automobiles (e.g., 30 psi to 35 psi). That is, in one or more embodiments, wheel 10 is adapted to be used for a tire with a tire pressure rating of from 50 psi to 125 psi, or from 60 psi to 125 psi, or from 60 psi to 100 psi, or from 50 psi to 80 psi, or from 50 psi to 65 psi.

Wheel 10, particularly the outer edges 12A, 12B thereof, can be sized with a diameter of from about 13 inches to about 18.5 inches. In one or more embodiments, trailer wheel 10, particularly the outer edges 12A, 12B thereof, can be sized with a diameter of about 13 inches, or about 14 inches, or about 15 inches, or about 16 inches, or about 18.5 inches.

As shown in the Figures, wheel 10 can be designed with zero wheel offset. That is, the hub mounting surface, which may also be referred to as the mounting pad, (i.e., ends of lug holes 36) can be in line with a centerline of the wheel. In other embodiments, wheel 10 can be designed with positive wheel offset. That is, the hub mounting surface can be in front (i.e., forward or toward the curbside) of the centerline of wheel 10.

Wheel 10 can be designed to be lug centric, which means wheel 10 would be centered on a corresponding vehicle using lug holes 36. That is, a center bore of the wheel 10 can be slightly larger than a corresponding vehicle hub. Where wheel 10 is lug centric, a hub ring can be utilized with the installation to fill the gap between the bore and the hub. In other embodiments, wheel 10 can be designed to be hub centric, where the center bore of the wheel 10 would be sized to match with the corresponding vehicle hub.

In light of the foregoing, the present invention advances the art by providing an improved trailer wheel. While particular embodiments of the invention are disclosed herein, the invention is not limited thereto or thereby inasmuch as variations will be readily appreciated by those of ordinary skill in the art. The scope of the invention shall be appreciated from the claims that follow.

What is claimed is:

1. A trailer wheel with a built-in center cap, the trailer wheel comprising the built-in center cap, which is integral with the trailer wheel;
an opposing pair of circular outer edges with a tire-receiving body therebetween, the opposing pair of circular outer edges including an external circular outer edge and an internal circular outer edge;
a plurality of spokes having first ends generally extending from the external circular outer edge and a portion of the tire-receiving body toward the built-in center cap, and having second ends extending to respective bottom portions of the built-in center cap;
the respective bottom portions of the built-in center cap extending in a curved manner to a body portion of the built-in center cap, where the body portion is shaped as a generally frustoconical hollow body;
wherein the trailer wheel has an outer diameter of from about 13 inches to about 18.5 inches; wherein the trailer wheel is suitable for use with a tire with a tire pressure rating of from 50 psi to 125 psi.

2. The trailer wheel of claim 1, the body portion including a portion of the built-in center cap partially extending beyond the external circular outer edge, where the partially extending portion extends beyond the external circular outer edge a distance of from about 5% to about 20% of a distance between the opposing pair of circular outer edges.

3. The trailer wheel of claim 2, where the partially extending portion extends beyond the external circular outer edge a distance of from about 5% to about 10% of the distance between the opposing pair of circular outer edges.

4. The trailer wheel of claim 2, where the partially extending portion extends beyond the external circular outer edge a distance of about 10% of the distance between the opposing pair of circular outer edges.

5. The trailer wheel of claim 1, the body portion of the built-in center cap including external shaped hole portions extending into lug holes.

6. The trailer wheel of claim 1, where the trailer wheel is made of an aluminum alloy.

7. The trailer wheel of claim 1, where the trailer wheel has zero wheel offset and is lug centric relative to a corresponding vehicle hub.

8. The trailer wheel of claim 1, the body portion of the built-in center cap extending to an outermost portion which receives a snap-in cap.

9. The trailer wheel of claim 8, the outermost portion including a notch for assistance with installation and removal of the snap-in cap.
